(19) United States
(12) Patent Application Publication
(10) Pub. No.: US 2026/0030475 A1
(43) Pub. Date: Jan. 29, 2026

(54) LAYERED ELECTRONIC DEVICE AND METHOD FOR MANUFACTURING SUCH A DEVICE

(71) Applicant: PARAGON ID, Argent-Sur-Sauldre (FR)

(72) Inventors: Pierre BENATO, Roquefort Les Pins (FR); Gilles MARTINEZ, Fréjus (FR)

(73) Assignee: PARAGON ID, Argent-Sur-Sauldre (FR)

(21) Appl. No.: 18/995,546

(22) PCT Filed: Mar. 1, 2023
(86) PCT No.: PCT/EP2023/055186

§ 371 Date: Jan. 16, 2025

(30) Foreign Application Priority Data
Aug. 1, 2022 (FR) 2207958

(51) Int. Cl. G06K 19/077

(52) U.S. Cl. CPC G06K 19/07722; G06K 19/07775

(57) ABSTRACT

A layered electronic device having: a first layer of a first thermoplastic polymer material, the first layer including a through cavity; an electronic module inserted at least partially within the through cavity of the first layer; and an adhesive second layer of a second material having an adherence higher than that of the first material, the adhesive second layer being at least partially in contact with the first layer and with the electronic module; the first layer being at least partially in contact with the electronic module.

### TECHNICAL FIELD

The present invention relates to layered electronic devices, in particular layered electronic devices obtained by pressing.

### PRIOR ART

Nowadays, identification cards, such as credit cards, identity cards, driver's license cards, cards for advertising purposes, ski package cards, or loyalty cards to benefit from discounts, etc., are made using a layered electronic device. Such a device comprises an electronic module integrated within a stack of layers of materials. In general, the used materials are thermoplastic polymers which deform, it is also said that they creep, under the action of pressing, and more particularly hot-pressing, so-called lamination.

In general, the electronic module is assembled with the layers of materials, some of which may contain information to be protected, for example identity information, in order to obtain a layered electronic device. Then, the layered electronic device is hot-pressed to merge the layers of materials in order to obtain a one-piece card body integrating an electronic module and information to be protected, so-called the final product or functional laminate. The final product allows preserving the integrity of the electronic module and of the different information written on the layers of material, preventing disassembly thereof and making it very tamper-resistant.

However, the integration of an electronic module within a stack of layers of materials generates stresses between the module and the layers of materials and creates weakness areas in the materials which are often the starting points of rupture of the materials. These stresses could have a destructive impact on the cards, when the cards are subjected to mechanical stresses such as daily wear, the tension is relieved in the form of cracks, and more particularly microcracks, in the layers of materials surrounding the module. Such microcracks contribute to the premature aging of the cards. Cracking could also be accelerated by mechanical stresses such as bendings and torsions which occur naturally throughout the service life of the card.

Mention may be made, for example, of the American patent application US2015/0298389 A1 which discloses a method for protecting an electrical component in a support layer of a functional laminate comprises the steps of providing the support layer with a first hole, a second hole and an opening connecting the first and second holes together, positioning an electrical component inside the first hole, placing a plastic material pellet in the second hole, and making the material of the pellet flow through the opening from the second hole towards the first hole, while circumventing the electrical component to surround it. Yet, such a method is complex, and requires an operation of sealing the first hole to obtain a functional laminate having a smooth appearance so as to be homogeneous with other cards.

Mention may be made of the European patent application EP3005244 A1, which discloses an intermediate electronic device comprising a support body provided with a cavity, an electronic module, a space at the interface between the module and the support body, and a flexible or elastic material arranged in the device so as to at least partially fill or cover the space between the module and the support body. Yet, an interstice might persist all around the electronic module, between the module and the support, and the electronic module is less well held within the device. Mention may also be made of the American patent application US2012/0201994 A1, which discloses a layered device comprising a thermoplastic film as a substrate layer; an opening in the substrate layer; a functional component arranged in the opening; an additional film over the substrate layer; and a flexible, elastic and temperature-resistant coating material, having a coefficient of thermal expansion higher than or equal to that of the substrate layer, surrounding the functional component. Yet, a large amount of a coating material having a specific coefficient of thermal expansion should be used, which makes the manufacturing method very expensive. Hence, one objective is to provide means for limiting the creation of cracks within a layered electronic device, in particular at the level of the electronic modules integrated within such devices. Another objective consists in providing means for keeping the electronic module immobile enough within the device while limiting the apparition of micro-cracks within the device. Another objective is to provide a layered electronic device that is simple to manufacture while allowing reducing the manufacturing costs.

### SUMMARY

According to one aspect, a layered electronic device is provided, comprising:
a first layer of a first thermoplastic polymer material, the first layer comprising a through cavity;
an electronic module inserted at least partially within the through cavity of the first layer; and
an adhesive second layer of a second material having a higher adhesion than that of the first material, the adhesive second layer being at least partially in contact with the first layer and with the electronic module.

The first layer is at least partially in contact with the electronic module.

Thus, by providing a device where the first layer is at least partially in contact with the electronic module, a good mechanical strength of the module is promoted. The adhesive second layer allows limiting a movement of the electronic module towards the first layer during a step of pressing at a temperature enabling creeping of the first material, so-called lamination step. Thus, the generation of stresses exerted by the electronic module on the first layer according to the direction of movement of the electronic module is limited. The creation of stresses according to a particular direction, which could promote the creation of cracks within the first layer, is avoided. Furthermore, during pressing, the first layer creeps towards the electronic module, held in position by the adhesive second layer, and when the first layer comes at least partially in contact with the electronic module, the stresses exerted by the first layer on the electronic module are homogeneously distributed around the electronic module.

According to another aspect, a method for manufacturing a layered electronic device is provided, comprising an assembly for obtaining a layered electronic device, the assembly comprising:
providing a first layer of a first thermoplastic polymer material, the first layer comprising a through cavity;
inserting an electronic module at least partially within the through cavity of the first layer so that the electronic module is located at a distance from the first layer;
providing an adhesive second layer of a second material having a higher adherence than the first material; and
bringing the adhesive second layer at least partially in contact with the first layer and with the electronic module.

The method comprises, after assembly, pressing the layered electronic device at a temperature enabling creeping at least of the first material so that the first layer creeps towards the electronic module in order to be brought at least partially in contact with the electronic module.

### BRIEF DESCRIPTION OF THE DRAWINGS

The aims, objects, as well as the features and advantages of the invention will appear more clearly from the detailed description of embodiments and implementations of the latter, illustrated by the following appended drawings, wherein:

FIG. 1 schematically illustrates a sectional view of an embodiment of a layered electronic device;

FIGS. 2 to 7 schematically illustrate sectional views of the main steps of a method for manufacturing a layered electronic device;

FIG. 8 schematically illustrates a top view of the step of the method illustrated in FIG. 4;

FIGS. 9 to 11 schematically illustrate sectional views of other embodiments of a layered electronic device;

FIGS. 12 and 13 schematically illustrate sectional views of other embodiments of a layered electronic device; and

FIG. 14 schematically illustrates a top view of another embodiment of a layered electronic device.

The drawings are given as examples and do not limit the invention. They are schematic representations of principle intended to facilitate understanding of the invention and are not necessarily plotted to the scale of practical applications.

### DETAILED DESCRIPTION

Before beginning a detailed review of embodiments and implementations of the invention, optional features are set out hereinafter, which could possibly be used in combination or alternatively.
The electronic module has a front face and a rear face, the first layer has a front face and a rear face, and the adhesive second layer has a front face at least partially in contact with the rear face of the electronic module and with the rear face of the first layer. By placing an adhesive layer at least partially in contact with the rear face of the electronic module, the amount of adhesive layer material to be used is limited.
The second material has a hardness strictly higher than that of the first material. Hardness allows limiting the deformation (or creeping) of the adhesive second layer during pressing, in order to avoid the adhesive second layer moving the electronic module towards the first layer according to a direction of movement.
The electronic module comprises a connection area and a logic circuit electrically coupled to the connection area, the device comprising an electrical circuit including an electrical wire having a first portion electrically coupled to the connection area and a second portion at least partially in contact with the first layer, the device comprising a third layer of a third thermoplastic polymer material, the third layer comprising a through cavity so that the electronic module is inserted at least partially within the through cavity of the third layer, the third layer being at least partially in contact with the first layer and with the first and second portions of the electrical wire. Thus, it is possible to provide a communicating electronic module, for example an RFID (or radio-frequency identification) tag.
The device comprises a fourth layer of a fourth thermoplastic polymer material, the fourth layer comprising a cavity so that the electronic module is inserted at least partially within the cavity of the fourth layer, the fourth layer being at least partially in contact with the third layer and with the electronic module, and wherein the third layer has a thickness larger than or equal to the sum of the thicknesses of the connection area and of the first portion, the thicknesses being measured according to an axis passing through the first, second and third layers. Thus, the stresses exerted on the first portion of the electrical wire are limited by the fourth layer during pressing.
The electronic module comprises a base having a first face forming the rear face of the electronic module and a second face opposite to the first face, the connection area being in contact with the second face, a thickness of the first layer being larger than or equal to a thickness of the base, the thicknesses being measured according to an axis passing through the first, second and third layers.
The fourth layer has a thickness larger than or equal to a difference between a thickness of the electronic module and the sum of the thicknesses of the first layer and of the third layer, the thicknesses being measured according to an axis passing through the first, second, third and fourth layers. Thus, we are assured that the fourth layer is flush with or covers the front face of the electronic module.
The first, third and fourth materials are based on the same thermoplastic polymer.
The device comprises a support layer of a fifth thermoplastic polymer material, the support layer comprising an additional cavity, the adhesive second layer being inserted at least partially within the additional cavity and the support layer being at least partially in contact with the first layer.
The second layer has a thickness smaller than or equal to that of the support layer, the thickness of the second layer being measured according to an axis passing through the first, second and third layers.
The electronic module has a front face and a rear face, the first layer has a front face and a rear face, and the adhesive second layer has a rear face at least partially in contact with the front face of the electronic module and with the front face of the first layer.
The electronic module comprises a connection area and a logic circuit electrically coupled to the connection area, the device comprising a first antenna electrically coupled to the connection area and a second antenna at least partially in contact with the first layer and inductively coupled at least with the first antenna.
The second antenna comprises a first portion arranged in a spiral-like fashion around the first antenna so as to be inductively coupled to the first antenna, and a second portion arranged in a spiral-like fashion around the first portion so as to be inductively coupled to an electronic apparatus located at a distance from the device.
The device comprises a third layer of a third thermoplastic polymer material, the third layer being at least partially in contact with the first layer, with the second layer and with the second antenna.
The device comprises an additional layer of an additional thermoplastic polymer material, the additional layer being at least partially in contact with the first layer and with the electronic module.
The additional material has a hardness strictly higher than that of the first material.
The device comprises a cover layer of a cover thermoplastic polymer material, the cover layer being at least partially in contact with the first layer and the additional layer.
The device comprises an additional cover layer of an additional thermoplastic polymer material, the additional cover layer covering the third layer.
The electronic module has a front face and a rear face, the first layer has a front face and a rear face, and the adhesive second layer has a front face, the assembly comprising bringing the adhesive second layer at least partially in contact with the rear face of the electronic module and with the rear face of the first layer.
The electronic module comprises a connection area and a logic circuit electrically coupled to the connection area, the assembly comprising providing an electric circuit including an electrical wire having a first portion electrically coupled to the connection area and a second portion brought at least partially in contact with the first layer, providing a third layer of a third thermoplastic polymer material, the third layer comprising a through cavity for inserting the electronic module at least partially within the through cavity of the third layer, and bringing the third layer at least partially in contact with the first layer and with the second portion so that the first portion is located at a distance from the third layer, and the pressing comprises creeping the third layer towards the first portion in order to be brought at least partially in contact with the first portion.
The assembly comprises providing a fourth layer of a fourth thermoplastic polymer material, the fourth layer comprising a cavity for inserting the electronic module at least partially within the cavity of the fourth layer, and bringing the fourth layer at least partially in contact with the third layer, the third layer having a thickness larger than or equal to the sum of the thicknesses of the connection area and of the first portion, the thicknesses being measured according to an axis passing through the first, second and third layers, the fourth layer being shaped so as to cover the first portion of the electrical wire, and the pressing comprises creeping the fourth layer towards the electronic module in order to be brought at least partially in contact with the electronic module.
The assembly comprises providing a support layer of a fifth thermoplastic polymer material, and the support layer covers a rear face of the adhesive second layer and at least partially the rear face of the first layer.
The adhesive second layer has a rear face, and the assembly comprises bringing the adhesive second layer at least partially in contact with the front face of the electronic module and with the front face of the first layer.
The assembly comprises providing a first antenna electrically coupled to the connection area and a second antenna brought at least partially in contact with the first layer so that the second antenna is inductively coupled at least with the first antenna.

By a material, a film, a layer, “based on” a material A, it should be understood, a material, a film, a layer comprising this material A alone or this material A and possibly other materials.

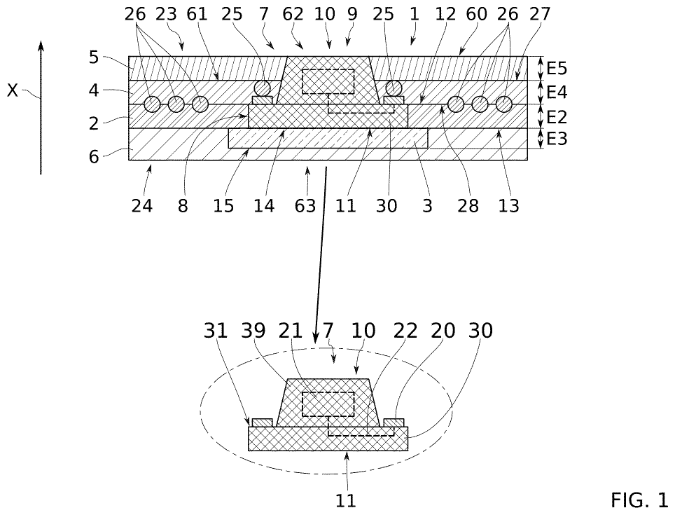

FIGS. 1 and 13 show a layered electronic device 1, in particular a functional device after having carried out a pressing step. By “functional device”, it should be understood a device 1 ready to be used, the device 1 preferably being an identification card, such as a credit card, an identity card, a driver's license card, a card for advertising purposes, a ski package card, or a loyalty card to benefit from discounts, etc. The device 1 is so-called layered because it includes a stack of several layers 2 to 6; and 203 to 205. The device 1 comprises at least one electronic module 7 inserted within the layers 2 to 6; and 203 to 205.

In general, the device 1 comprises at least one first layer 2 of a first thermoplastic polymer material, the first layer 2 comprising a through cavity 8. The first layer 2 is intended to form a support for the electronic module 7. The thermoplastic polymer material is a material capable of creeping under the effect of pressing, in particular pressing at a specific temperature. For example, the thermoplastic polymer material may be based on polycarbonate. In this case, the specific temperature used during pressing may be comprised between 165° C. and 190° C. Moreover, the electronic module 7 is inserted at least partially within the through cavity 8 of the first layer 2. In particular, creeping of the layers 2, 4 to 6; and 203 to 205 allows filling the interstices between the electronic module 7 and the different layers 2, 4 to 6; and 203 to 205, so-called support layers, during the manufacture of the device 1.

More particularly, the device 1 comprises an adhesive second layer 3 of a second material having an adherence higher than that of the first material, preferably strictly higher than that of the first material. The adhesive second layer 3 is at least partially in contact with the first layer 2 and with the electronic module 7. The adhesive second layer 3 is configured to keep the electronic module 7 immobile during the pressing step. Indeed, pressing leads to a creeping of the layers 2, 4 to 6; and 203 to 205 which could move the module 7 and lead to the creation of weakness areas. The second layer 3 may possibly creep slightly during the pressing step, but the material of the second layer 3 is selected so that the second layer 3 creeps less than the other layers 2, 4 to 6; and 203 to 205 of the device 1. Positioning the adhesive second layer 3 in contact with both the module 7 and the first layer 2 allows keeping the electronic module 7 immobile while enabling the first layer 2 to creep towards the electronic module 7 during pressing. Thus, a device 1 wherein the first layer 2 is at least partially in contact with the electronic module 7 is obtained. This allows promoting holding of the electronic module 7 in position within the device 1.

For example, the second material is based on polyamide. Furthermore, the second material may have a bonding force higher than or equal to 14 N/mm². By “bonding force”, it should be understood the required force to be exerted on the second material to separate it from a support on which it is bonded. In other words, the required force corresponds to a shear force.

In general, the device 1 comprises several layers 2 to 6; and 203 to 205, arranged on top of one another, according to a main axis X. Moreover, the electronic module 7 has a front face 10 and a rear face 11, the first layer 2 has a front face 12 and a rear face 13, and the adhesive second layer 3 has a front face 14 and a rear face 15. More particularly, the front face 14 of the adhesive second layer 3 is at least partially in contact with the rear face 11 of the electronic module 7 and with the rear face 13 of the first layer 2. Preferably, the surface of the front face 14 of the adhesive second layer 3 is strictly larger than the surface of the rear face 11 of the electronic module 7. In other words, the adhesive second layer 3 covers the rear face 11 of the electronic module 7. When the device 1 includes the first two layers 2, 3, the main axis X passes through the second layer 3 and the first layer 2, successively. When the device 1 includes several layers 2 to 6, the main axis X passes through the second layer 3 and the first layer 2, the third layer 4 and the fourth layer 5, successively. In other words, the main axis X is perpendicular to the planes in which the faces 12 to 15 of the first and second layers 2, 3 generally extend. More particularly, the main axis X is perpendicular to the planes in which the faces of the layers 2 to 6 of the device 1 generally extend.

Advantageously, the second material of the adhesive second layer 3 has a hardness strictly higher than that of the first material of the first layer 2, in particular in order to keep the electronic module 7 immobile during pressing of the device 1. Furthermore, the hardness of the material of the second layer 3 allows limiting creeping thereof, during pressing, and thus improving holding of the electronic module 7 in position. For example, it is possible to make the second layer of polyamide having a hardness comprised between 80 and 100 Shore D. The Shore D unit is a scale for measuring the hardness of the materials, i.e. the measurement of the resistance of a material to penetration. The Shore D scale is made using an instrument that allows measuring the depth of depression of a penetrator by application on the material. Moreover, it is possible to make the first layer 2 of polycarbonate having a hardness comprised between 60 and 78 Shore D.

According to another advantage, the electronic module 7 comprises a connection area 20 and a logic circuit 21 electrically coupled, via a conductive connection 22, to the connection area 20. Furthermore, the device 1 comprises an electrical circuit 23 including an electrical wire 24 having a first portion 25 electrically coupled to the connection area 20 and a second portion 26 at least partially in contact with the first portion layer 2. In particular, the first portion 25 is connected directly to the connection area 20. The second portion 26 is placed in contact with the first layer 2, for example the second portion 26 penetrates partially into the first layer 2, as illustrated in FIGS. 1; 4 to 11. Moreover, the device 1 comprises a third layer 4 of a third thermoplastic polymer material for integrating the electrical circuit 23. The third layer 4 includes a front face 27 and a rear face 28. The third layer 4 further comprises a through cavity 9 so that the electronic module 7 is inserted at least partially within the through cavity 9 of the third layer 4. In other words, the through cavity 9 of the third layer 4 is placed facing, or opposite, the through cavity 8 of the first layer 2. The third layer 4 is at least partially in contact with the first layer 2 and with the first and second portions 25, 26 of the electrical wire 24. The electrical circuit 24 may consist of an antenna, and a device 1 is thus provided comprising a communicating electronic module 7, for example an RFID tag.

Moreover, the second layer 3 may have a thickness E3 smaller than or equal to that E2 of the first layer 2. The thicknesses E2, E3 of the first and second layers 2, 3 being measured according to an axis passing through the first, second and third layers 2 to 4, in particular according to the main axis X. Preferably, the thickness E3 of the second layer 3 is strictly smaller than that of the first layer 2, thus, it is possible to reduce the amount of the second material to be used, compared to that of the first material.

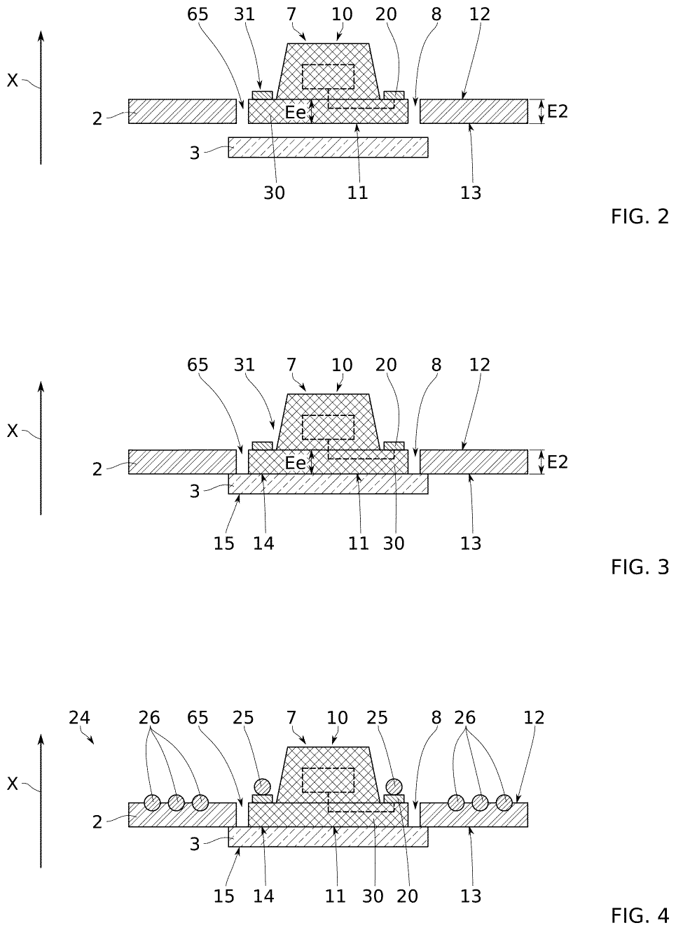

According to another advantage, the electronic module 7 comprises a base 30 having a first face forming the rear face 14 of the electronic module 7 and a second face 31 opposite to the first face. The electronic module 7 may comprise a package 39 within which the logic circuit 21 is integrated. The package 39 projects from the second face 31 of the electronic module 7. The connection area 20 is in contact with the second face 31. Preferably, the thickness E2 of the first layer 2 is larger than or equal to a thickness Ee of the base 30, the thicknesses E2, Ee being measured according to an axis passing through the first, second and third layers 2 to 4, in particular according to the main axis X, as illustrated in FIG. 2.

Moreover, the device 1 may comprise a fourth layer 5 of a fourth thermoplastic polymer material, the fourth layer 5 comprising a front face 60 and a rear face 61. The fourth layer 5 has front and rear faces 60, 61 having non-continuous surfaces. In other words, the fourth layer 5 comprises a cavity 62 so that the electronic module 7 is inserted at least partially within the cavity 62 of the fourth layer 5. The cavity 62 of the fourth layer 5 may be open-through or blind. Furthermore, the fourth layer 5 is at least partially in contact with the third layer 4 and with the electronic module 7. The fourth layer 5 has a thickness E5 larger than or equal to a difference between a thickness of the electronic module 7 and the sum of the thicknesses of the first layer E2 and of the third layer E4, the thicknesses being measured according to the main axis X. This means that E5=Em−(E2+E4), where Em corresponds to the thickness of the electronic module 7 measured according to the main axis X. As illustrated in FIGS. 1, 6, 7, and 9 to 11, the front face 60 of the fourth layer 5 is flush with the front face 10 of the electronic module 7. The thickness E5 of the fourth layer 5 is measured according to an axis passing through the first, second, third and fourth layers 2 to 5, in particular according to the main axis X.

Furthermore, the third layer 4 has a thickness E4 larger than or equal to the sum of the thicknesses of the connection area 20 and of the first portion 25 of the electrical wire 24, the thicknesses being measured according to the main axis X. Thus, the stresses exerted by the fourth layer 5 on the first portion 25 are limited during creeping of the fourth layer 5 during pressing.

In particular, the front face 27 of the third layer 4 is at least partially in contact with the rear face 61 of the fourth layer 5.

The first, third and fourth materials may be based on the same thermoplastic polymer, preferably made of polycarbonate, and more preferably of polycarbonate having a hardness comprised between 75 and 85 Shore D, in order to simplify the manufacture of the device 1. Advantageously, the second material has a hardness strictly higher than those of the first, third and fourth materials. Advantageously, the device 1 comprises a support layer 6 of a fifth thermoplastic polymer material. Preferably, the fifth material is based on the same material as that of the first, third and fourth layers 2, 4 and 5. The support layer 6 has front and rear faces which could be continuous so as to cover the rear face 15 of the adhesive second layer 3 and at least partially the rear face 13 of the first layer 2, as illustrated in FIG. 10. Alternatively, the support layer 6 may comprise an additional through or blind cavity 63 for inserting the adhesive second layer 3 at least partially. The additional cavity 63 may be blind, as illustrated in FIGS. 1, 7 and 9, when the front face of the support layer 6, i.e. the face at least partially in contact with the rear face 13 of the first layer 2, is continuous. In this case, the support layer 6 is at least partially in contact with the first layer 2. Alternatively, as illustrated in FIG. 11, the additional cavity 63 is open-through and the adhesive second layer 3 is inserted into the additional cavity 63 at least partially.

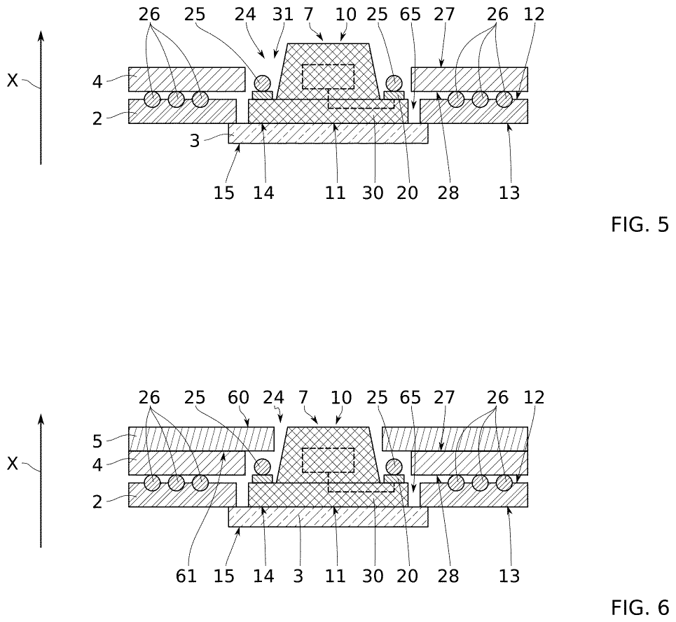

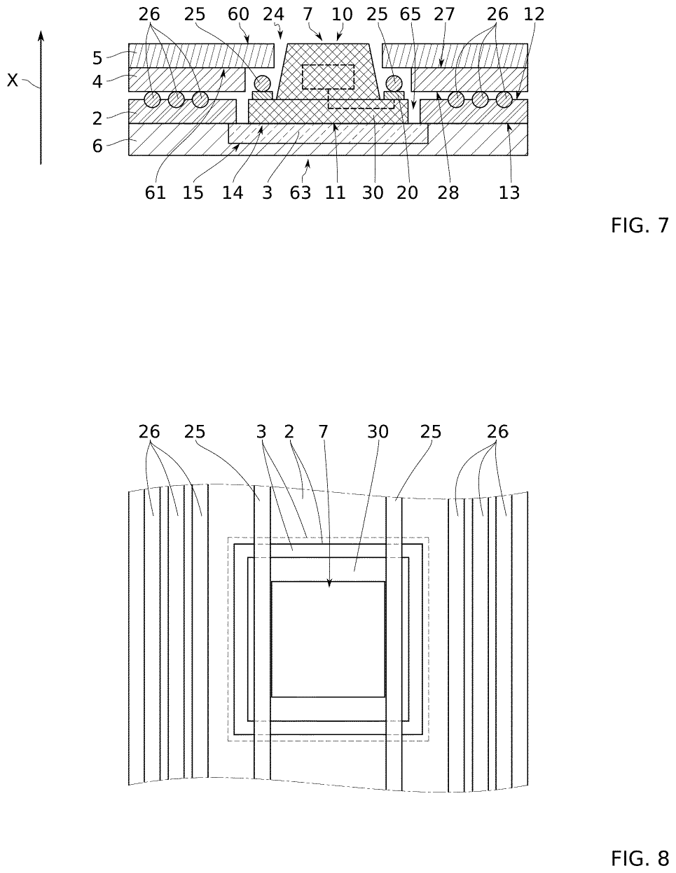

FIGS. 2 to 7 show the main steps of a method for manufacturing the layered electronic device 1 as defined hereinbefore. In general, the method comprises an assembly to obtain a layered electronic device 1. The assembly comprises providing the first layer 2 of a first thermoplastic polymer material, the first layer 2 comprising a through cavity 8, providing the electronic module 7 and providing the adhesive second layer 3 of a second material having an adherence higher than that of the first material, as illustrated in FIG. 2. The assembly further comprises inserting the electronic module 7 at least partially within the through cavity 8 of the first layer 2 so that the electronic module 7 is located at a distance from the first layer 2. In other words, there is a space 65 between the module 7 and the first layer 2. Then, the assembly comprises bringing the adhesive second layer 3 at least partially in contact with the first layer 2 and with the electronic module 7. For example, the module 7 may be mounted on the front face 14 of the second layer 3, and then the second layer 3 is brought in contact with the first layer 2. Afterwards, the assembly may comprise placing the portions 25, 26 of the electrical wire 24 over the first layer 2 and the connection area 20, illustrated in FIGS. 4 and 8. For example, it is possible to weld the first portion 25 on the connection area 20. Afterwards, it is possible to place the third layer 4 at least partially in contact with the first layer 2. Preferably, the rear face of the third layer 4 is brought at least partially in contact with the front face of the first layer 2, as illustrated in FIG. 5. Furthermore, it is possible to bring the fourth layer 5 at least partially in contact with the third layer 4, as illustrated in FIG. 6. According to one implementation, illustrated in FIG. 6, the third layer 4 has a thickness E4 larger than or equal to the sum of the thicknesses of the connection area 20 and of the first portion 25 of the electrical wire 24. Thus, the fourth layer 5 may be in contact with the first portion 25 of the electrical wire 24, by being placed over the first portion 25. Preferably, the third layer 4 has a thickness E4 strictly larger than the sum of the thicknesses of the connection area 20 and of the first portion 25 of the electrical wire 24. In this case, the first portion 25 is located at a distance from the rear face 61 of the fourth layer 5, i.e. the fourth layer 5 is not in contact with the first portion 25. Thus, the stresses exerted on the first portion 25 by the fourth layer 5 during pressing are further limited. This allows for a better creeping of the fourth layer 5 towards the electronic module 7 to cover the first portion 25 of electrical wire 24 more easily. Advantageously, the assembly may comprise bringing the support layer 6 at least partially in contact with the first layer 2, as illustrated in FIG. 7.

After assembly, the method comprises pressing the layered electronic device 7 at a temperature enabling creeping at least of the first material so that the first layer 2 creeps towards the electronic module 7 in order to be brought at least partially in contact with the electronic module 7. Advantageously, the specific temperature also enables creeping of the materials of the first, third, fourth and fifth layers 2, 3 to 5, as well as creeping of the material of the support layer 6. In other words, the specific temperature is selected so as to be at least higher than or equal to the maximum value of the creep temperatures of each of the first, third to fifth materials.

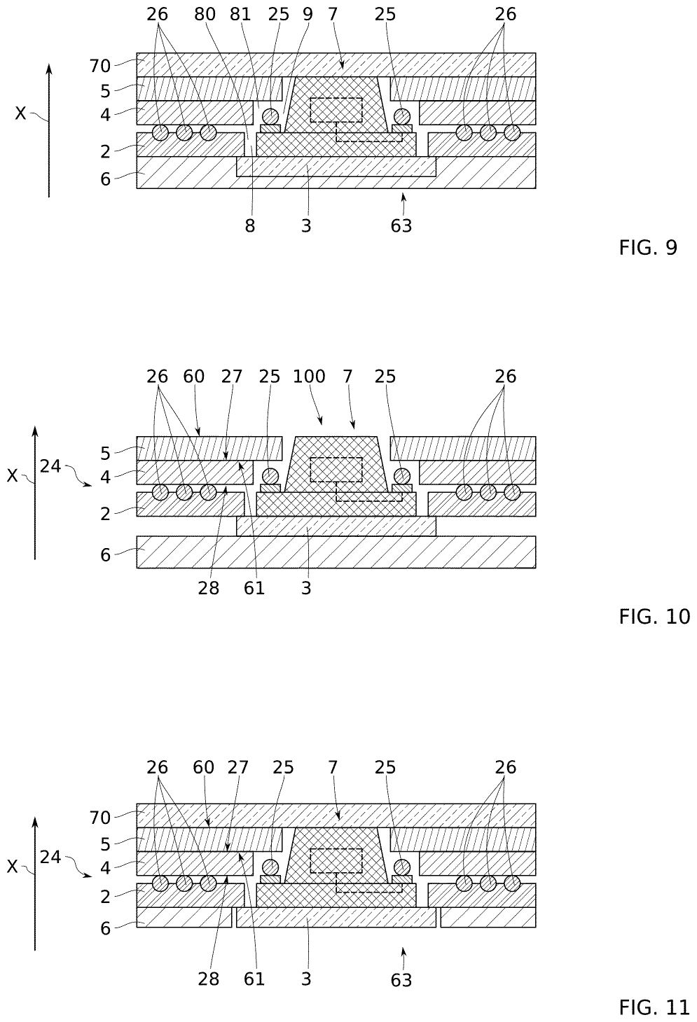

FIG. 9 shows a device 1 before the pressing step, comprising an additional layer 70 of a material, preferably identical to that of the first layer 2, to cover the electronic module 7. The additional layer 70 has front and rear faces having continuous surfaces to cover the electronic module 7 and the front face 60 of the fourth layer 5. Furthermore, the third layer 4 is located at a distance from the first portion 25 of the wire 24. For example, the first layer 2 has an inner edge 80 forming the through cavity 8 of the first layer 2, the third layer 4 has an inner edge 81 forming the through cavity 9 of the third layer 4, the inner edges 80, 81 could be offset according to the main axis X, as illustrated in FIGS. 5 to 7, and 9 to 11, or be aligned according to the main axis X. Preferably, the third layer 4 is located at a distance from the first portion 25 to avoid exerting stresses on the first portion 25 during creeping of the third layer 4. The first portion 25 is inserted at least partially within the through cavity 9 of the third layer 4. In this case, creeping of the third layer 4 and of the fourth layer 5 is promoted to cover the first portion 25 of the wire 24.

According to still another variant, the through cavity 9 of the third layer 4 has a diameter larger than or equal to that of the through cavity 8 of the first layer 2. The diameters are measured according to an axis perpendicular to the main axis X.

FIG. 10 shows a device 1 before the pressing step, wherein the fourth layer 5 comprises an additional cavity 100, i.e. the front and rear faces 60, 61 of the fourth layer 5 are not continuous.

FIG. 11 shows a device 1 before pressing wherein the support layer 6 comprises a through cavity 63 for inserting the adhesive second layer 3 at least partially.

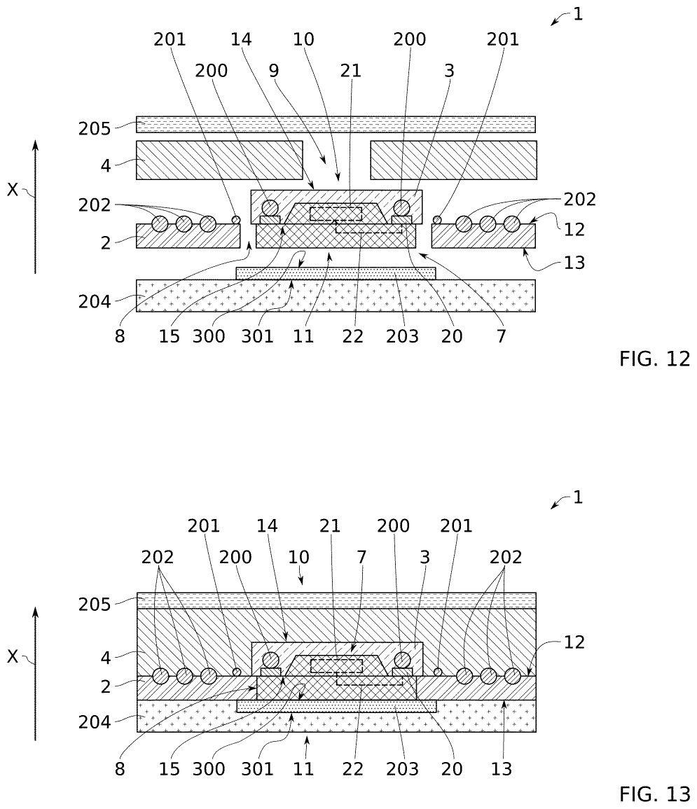

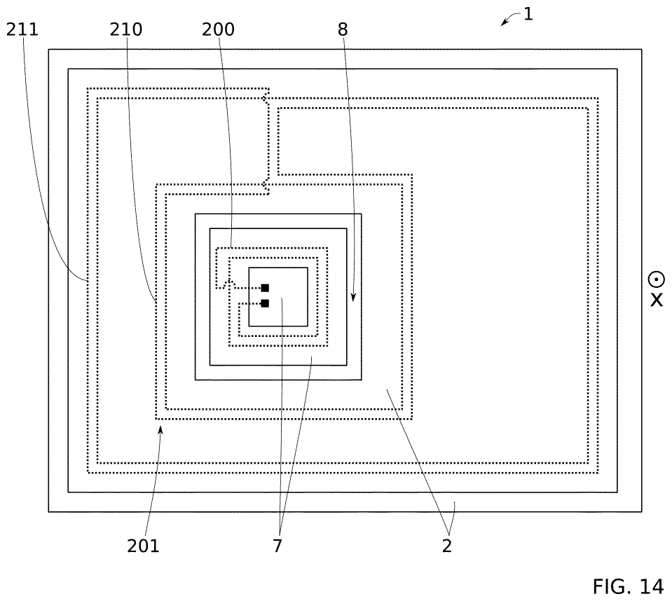

FIGS. 12 to 14 show another embodiment of the layered electronic device 1. According to this other embodiment, the adhesive second layer 3 has a rear face 15 at least partially in contact with the front face 10 of the electronic module 7 and with the front face 12 of the first layer 2.

Preferably, the surface of the rear face 15 of the adhesive second layer 3 is strictly larger than the surface of the front face 10 of the electronic module 7. In other words, the adhesive second layer 3 covers the front face 10 of the electronic module 7. The main axis X passes, successively, through the first layer 2 and the second layer 3.

According to another advantage, the device 1 comprises a first antenna 200 electrically coupled to the connection area 20 of the electronic module 7, and a second antenna 201 at least partially in contact with the first layer 2. More particularly, the second antenna 201 is inductively coupled at least with the first antenna 200. In other words, the second antenna 201 is not electrically connected by an electrical wire to the first antenna 200. The inductive coupling of the first and second antennas 200, 201 to one another is also so-called magnetic coupling. The first and second antennas 200, 201 are intended to enable a data exchange, by electromagnetic waves, with an electronic apparatus located at a distance from the device, for example a credit card reader. Thus, the energy of the electromagnetic waves originating from, or transmitted to, the second antenna 201 barely affects the electronic module 7 because there is no wired electrical connection between the second antenna 201 and the electronic module 7. In particular, the first antenna 200 forms a closed circuit with the logic circuit 21 in order to be able to receive or supply an electrical signal. For example, each of the first and second antennas 200, 201 comprises an electrical wire and it is said that the first and second antennas 200, 201 are wired. Alternatively, an antenna 200, 201, or each antenna 200, 201, may comprise an electrically-conductive flat strip. According to another variant, an antenna 200, 201, or each antenna 200, 201, may be made by depositing an electrically-conductive ink.

In general, the second antenna 201 comprises at least one portion 210, 211 arranged in a spiral-like fashion around the first antenna 200. Advantageously, to improve the data exchange, the second antenna 201 may comprise a first portion 210 arranged in a spiral-like fashion around the first antenna 200 so as to be inductively coupled to the first antenna 200, and a second portion 211 arranged in a spiral-like fashion around the first portion 210 so as to be inductively coupled to an electronic apparatus located at a distance from the device. In general, each antenna 200, 201 comprises an electrically-conductive element (like an electrical wire, an electrically-conductive strip, or an electrically-conductive ink) arranged within the device in a spiral-like fashion in order to produce and receive a magnetic field enabling an inductive coupling between the antennas 200, 201. For example, the first and second antennas 200, 201 consist of planar coils.

In particular, the first and second portions 210, 211 are respectively arranged in a spiral-like fashion so that the diameters of the turns of the second portion 211 are strictly larger than those of the turns of the first portion 210. Also note the first portion 210, small loop 210, and the second portion 211, large loop 211, because the diameters of the turns of the large loop 211 are strictly larger than those of the small loop 210. More particularly, a distance separates the turn of the large proximal loop 211 the closest to the electronic module 7 with the turn of the small loop 210 the farthest from the electronic module 7. The distance is strictly larger than a difference between the turns of the small loop 210. Thus, the large loop 211 is configured to exchange data with an electronic device located at a distance from the device 1. Moreover, the small loop 210 is configured to exchange these data with the first antenna 200, to transmit and receive these data with the electronic module 7, in particular with the logic circuit 21 of the module 7. In this case, the small loop 210 serves as a relay for data exchanges between the electronic module 7 and the electronic apparatus located at a distance from the device 1. The second antenna 201 is also so-called power antenna, because it is configured to receive electromagnetic waves having a frequency comprised between 10 and 20 MHz. More particularly, the large loop 211 is electrically coupled to the small loop 210. For example, the same electrically-conductive element is arranged in a spiral-like fashion so as to form the small and large loops 210, 211, respectively. For example, the same electrically-conductive element forming the small and large loops may have its two ends connected together.

In the embodiment illustrated in FIGS. 12 and 13, the device 1 may comprise the third layer 4, as defined hereinabove, of the third thermoplastic polymer material. In this embodiment, the third layer 4 is at least partially in contact with the first layer 2, with the second layer 3 and with the second antenna 201. The third layer 4 allows protecting the electronic module 7 and the second antenna 201, and more particularly improving the hold of the electronic module 7 with the first layer 2. The device 1 may further comprise an additional layer 203 of an additional thermoplastic polymer material, the additional layer 203 being at least partially in contact with the first layer 2 and with the electronic module 7. The additional layer 203 has a front face 300 intended to be in contact with the electronic module 7, and a rear face 301. Preferably, the additional layer 203 covers the rear face 11 of the electronic module 7, in other words the surface of the front face 300 of the additional layer 203 is strictly larger than that of the rear face 11 of the electronic module 7.

The device 1 may also comprise a cover layer 204 of a thermoplastic polymer cover material, the cover layer 204 being at least partially in contact with the first layer 2 and the additional layer 203. For example, the additional layer 203 comprises at least one adhesive face 300, 301. Preferably, the rear face 301 of the additional layer 203 is adhesive. Thus, the adhesive rear face 301 of the additional layer 203 allows keeping a portion of the cover layer 204 located opposite the electronic module 7 immobile during the pressing step. Indeed, the pressing leads to creeping of the layers 2, 4 to 6; and 203 to 205 which could move the portion of the cover layer 204 located opposite the electronic module 7 and lead to the creation of weakness areas between the rear face 11 of the electronic module 7 and the cover layer 204. For example, the additional layer 203 may comprise a support layer made of polycarbonate having a face over which a glue is placed. The adhesive may be a polyurethane resin, or an epoxy resin, i.e. an epoxide polymer (or polyepoxide). In another example, the additional layer 203 comprises an additional thermoplastic polymer material that can be polymerized by ultraviolet radiation. In this case, the additional layer 203 is placed, in the form of a paste, in contact with the cover layer 204, then the additional layer 203 is polymerized by ultraviolet radiation. The polymerization leads to hardening of the additional layer 203 which adheres to the cover layer 204. Advantageously, the additional material of the additional layer 203 has a hardness strictly higher than that of the first material. For example, the hardness of the additional material may be comprised between 80 and 100 Shore D. For example, the additional material is based on polyamide. For example, the additional material is identical to the second material of the second layer 3.

The device 1 may further comprise an additional cover layer 205 of an additional thermoplastic polymer material, the additional cover layer 205 covering the third layer 4.

The cover and additional materials may be based on the same thermoplastic polymer as that one of the first layer 2, preferably made of polycarbonate, and more preferably of polycarbonate having a hardness comprised between 75 and 85 Shore D, in order to simplify the manufacture of the device 1.

When the device 1 includes the layers 2 to 4; 203 to 205, the main axis X passes, successively, through the cover layer 204, the additional layer 203, the first layer 2, the second layer 3, the third layer 4 and the additional cover layer 205.

Moreover, FIGS. 12 and 13 illustrate the main steps of another embodiment of the method for manufacturing the layered device 1. According to this other embodiment, the assembly comprises bringing the adhesive second layer 3 at least partially in contact with the front face 10 of the electronic module 7. Then, simultaneously or preferably after bringing in contact with the front face, the method comprises bringing the adhesive second layer 3 in contact with the front face 12 of the first layer 2. Moreover, the assembly may comprise, before bringing the adhesive second layer 3 in contact with the front face 10 of the electronic module 7, electrically coupling, for example by welding, the first antenna 200 to the connection area 20 of the electronic module. Then, the method may comprise bringing the second antenna 201 at least partially in contact with the first layer 2.

1. A layered electronic device, comprising:
a first layer of a first thermoplastic polymer material, the first layer comprising a through cavity;
an electronic module inserted at least partially within the through cavity of the first layer; and
an adhesive second layer of a second material having a higher adhesion than that of the first material, the adhesive second layer being at least partially in contact with the first layer and with the electronic module;
wherein the first layer is at least partially in contact with the electronic module.

2. The device according to claim 1, wherein the electronic module has a front face and a rear face, the first layer has a front face and a rear face, and the adhesive second layer has a front face at least partially in contact with the rear face of the electronic module and with the rear face of the first layer.

3. The device according to claim 1, wherein the electronic module comprises a connection area and a logic circuit electrically coupled to the connection area, the device comprising an electrical wire having a first portion electrically coupled to the connection area and a second portion at least partially in contact with the first layer, the device comprising a third layer of a third thermoplastic polymer material, the third layer comprising a through cavity so that the electronic module is inserted at least partially within the through cavity of the third layer, the third layer being at least partially in contact with the first layer and with the first and second portions of the electrical wire.

4. (canceled)

5. The device according to claim 3, wherein the electronic module comprises a base having a first face forming a rear face of the electronic module and a second face opposite to the first face, the connection area being in contact with the second face, a thickness of the first layer being larger than or equal to a thickness of the base, the thicknesses being measured according to an axis passing through the first, second and third layers.

6. The device according to claim 5, further comprising a fourth layer of a fourth thermoplastic polymer material, the fourth layer comprising a cavity so that the electronic module is inserted at least partially within the cavity of the fourth layer, the fourth layer being at least partially in contact with the third layer and with the electronic module, and wherein the fourth layer has a thickness larger than or equal to a difference between a thickness of the electronic module and a sum of the thicknesses of the first layer and of the third layer, the thicknesses being measured according to an axis passing through the first, second, third and fourth layers.

7. The device according to claim 5, further comprising a fourth layer of a fourth thermoplastic polymer material, the fourth layer comprising a cavity so that the electronic module is inserted at least partially within the cavity of the fourth layer, the fourth layer being at least partially in contact with the third layer and with the electronic module, and wherein the first, third and fourth materials are based on a same thermoplastic polymer.

8. The device according to claim 7, comprising a support layer of a fifth thermoplastic polymer material, the support layer comprising an additional cavity, the adhesive second layer being inserted at least partially within the additional cavity and the support layer being at least partially in contact with the first layer.

9. The device according to claim 8, wherein the second layer has a thickness smaller than or equal to that of the support layer, the thickness of the second layer being measured according to an axis passing through the first, second and third layers.

10. The device according to claim 1, wherein the electronic module has a front face and a rear face, the first layer has a front face and a rear face and the adhesive second layer has a rear face at least partially in contact with the front face of the electronic module and with the front face of the first layer.

11. The device according to claim 10, wherein the electronic module comprises a connection area and a logic circuit electrically coupled to the connection area, the device comprising a first antenna electrically coupled to the connection area and a second antenna at least partially in contact with the first layer and inductively coupled at least with the first antenna.

12. The device according to claim 11, wherein the second antenna comprises a first portion arranged in a spiral-like fashion around the first antenna so as to be inductively coupled to the first antenna, and a second portion arranged in a spiral-like fashion around the first portion so as to be inductively coupled to an electronic apparatus located at a distance from the device.

13. The device according to claim 11, further comprising a third layer of a third thermoplastic polymer material, the third layer being at least partially in contact with the first layer, with the second layer and with the second antenna.

14. The device according to claim 13, comprising an additional layer of an additional thermoplastic polymer material, the additional layer being at least partially in contact with the first layer and with the electronic module.

15. The device according to claim 14, wherein the additional material has a hardness strictly higher than that of the first material.

16. The device according to claim 14, comprising a cover layer of a thermoplastic polymer cover material, the cover layer being at least partially in contact with the first layer and the additional layer.

17. (canceled)

18. The device according to claim 1, wherein the second material has a hardness strictly higher than that of the first material.

19. A method for manufacturing a layered electronic device, comprising an assembly for obtaining a layered electronic device, the assembly comprising:
providing a first layer of a first thermoplastic polymer material, the first layer comprising a through cavity;
inserting an electronic module at least partially within the through cavity of the first layer so that the electronic module is located at a distance from the first layer;
providing an adhesive second layer of a second material having a higher adherence than the first material; and
bringing the adhesive second layer at least partially in contact with the first layer and with the electronic module;
wherein the method comprises, after assembly, pressing the layered electronic device at a temperature enabling creeping at least of the first material so that the first layer creeps towards the electronic module in order to be brought at least partially in contact with the electronic module.

20. The method according to claim 19, wherein the electronic module has a front face and a rear face, the first layer has a front face and a rear face, and the adhesive second layer has a front face, the assembly comprising bringing the adhesive second layer at least partially in contact with the rear face of the electronic module and with the rear face of the first layer.

21. The method according to claim 20, wherein the electronic module comprises a connection area and a logic circuit electrically coupled to the connection area, the assembly comprising providing an electrical wire having a first portion electrically coupled to the connection area and a second portion brought at least partially in contact with the first layer, providing a third layer of a third thermoplastic polymer material, the third layer comprising a through cavity for inserting the electronic module at least partially within the through cavity of the third layer, and bringing the third layer at least partially in contact with the first layer and with the second portion so that the first portion is located at a distance from the third layer, and the pressing comprises creeping the third layer towards the first portion in order to be brought at least partially in contact with the first portion.

22-23. (canceled)

24. The method according to claim 19, wherein the electronic module has a front face and a rear face, the first layer has a front face and a rear face, and the adhesive second layer has a rear face, the assembly comprising bringing the adhesive second layer at least partially in contact with the front face of the electronic module and with the front face of the first layer.

25-26. (canceled)
